(19) United States
(12) Patent Application Publication
(10) Pub. No.: US 2011/0079051 A1
(43) Pub. Date: Apr. 7, 2011

(54) HIGH EFFICIENCY FIN ASSEMBLY FOR MAKING GLASS FIBERS

(76) Inventors: Byron L. Bemis, Newark, OH (US); Terry L. Anderson, Thornville, OH (US)

(21) Appl. No.: 12/574,991

(22) Filed: Oct. 7, 2009

(51) Int. Cl. C03B 37/10; C03B 37/08

(52) U.S. Cl. 65/481; 65/512; 65/498

(57) ABSTRACT

Cooling fin assemblies constructed of materials suitable for use in manufacturing glass filaments are provided. The cooling fin assemblies include a manifold having a first end, a second end and an internal passage therebetween. The internal passage is configured for a flow of cooling fluid. A plurality of baffles is positioned within the internal passage. A plurality of blades is connected to the manifold. The blades are configured to conduct heat to the manifold. The baffles are configured to create a serpentine flow path for the cooling fluid within the manifold.

### BACKGROUND

In the manufacture of continuous glass filaments, glass can be melted in a glass melter or furnace and flows to one or more bushings. Each bushing has a number of nozzles or tips through which streams of molten glass flow. The glass streams are mechanically pulled from the nozzles by a winding apparatus to form continuous glass filaments.

The temperature of the molten glass within the bushing must be high enough to maintain the glass in a liquid state. However, if the temperature is too high, the molten glass will not cool sufficiently so as to become viscous enough to form filaments after passing through the bushing tips. Thus, the glass must be quickly cooled or quenched after it flows from the bushing tips and forms glass filaments. If the glass cools too slowly, the glass filaments will break and the filament forming process will stop.

There are numerous types of apparatus for cooling the glass filament forming area beneath a filament forming machine. A conventional cooling apparatus uses air, water, or both to transfer heat from the filament forming area beneath a bushing and cool the glass filaments. An example of a glass filament forming apparatus is disclosed in U.S. Pat. No. 6,192,714 to Dowlati et al., the disclosure of which is expressly incorporated herein by reference.

Cooling apparatus can include a plurality of cooling fins. Filaments drawn from the bushing can pass on either side of a cooling fin. Heat from the glass can be radiantly and convectively transferred to the fins from the glass filaments. The heat can pass conductively through the fins and to a water-cooled manifold. Such cooling fins increase the surface area of the cooling apparatus, thereby increasing the amount of heat that can be transferred from the filaments and from the filament forming area.

A cooling fluid supply, such as water, can enter the manifold, travel through a channel within the manifold, and exit the opposite end of the manifold as a cooling fluid return. The cooling fluid absorbs heat as it flows through the manifold, thereby cooling the manifold, the cooling fins, and indirectly, the filament forming area. However, the amount of heat that such a cooling apparatus can remove from the filament forming area can be limited. If heat can be more rapidly removed from the filament forming area beneath a bushing, the operating temperatures of the bushing and the molten glass in the bushing can be increased, thereby allowing overall throughput to be increased.

Accordingly, it would be advantageous to provide an improved method and apparatus for cooling a filament forming area beneath a bushing to remove a greater amount of heat.

### SUMMARY

In accordance with embodiments of this invention there are provided cooling fin assemblies constructed of materials suitable for use in manufacturing glass filaments. The cooling fin assemblies include a manifold having a first end, a second end and an internal passage therebetween. The internal passage is configured for a flow of cooling fluid. A plurality of baffles is positioned within the internal passage. A plurality of blades is connected to the manifold. The blades are configured to conduct heat to the manifold. The baffles are configured to create a serpentine flow path for the cooling fluid within the manifold.

In accordance with embodiments of this invention there are also provided apparatus configured for the manufacture of glass filaments. The apparatus include a bushing having a plurality of nozzles. The bushing is configured to provide a supply of molten glass to the plurality of nozzles. The nozzles are configured for the production of glass filaments. The nozzles form a filament forming area. A cooling fin assembly is positioned in the filament forming area. The cooling fin assembly includes a plurality of blades connected to a manifold. The manifold has a first end, a second end and an internal passage therebetween. The internal passage is configured for a flow of cooling fluid. A plurality of baffles is positioned within the internal passage. The plurality of blades is configured to conduct heat to the manifold. The baffles are configured to create a serpentine flow path for the cooling fluid within the manifold. A mechanism is configured to collect the formed filaments.

In accordance with embodiments of this invention there are also provided methods of manufacturing glass filaments. The methods include the steps of providing a bushing, the bushing configured to provide a supply of molten glass to the plurality of nozzles, the plurality of nozzles configured for the production of glass filaments, wherein the nozzles form a filament forming area, positioning a cooling fin assembly in the filament forming area, the cooling fin assembly including a plurality of blades connected to a manifold, the manifold having a first end, a second end and an internal passage therebetween, the internal passage configured for a flow of cooling fluid, a plurality of baffles being positioned within the internal passage, the plurality of blades configured to conduct heat to the manifold, wherein the baffles are configured to create a serpentine flow path for the cooling fluid within the manifold, providing a supply of molten glass to the bushing, forming glass filaments through the nozzles, providing a flow of cooling fluid through the manifold, absorbing and conducting heat from the filament forming area to the manifold and transferring heat from the manifold to the cooling fluid as the cooling fluid flows through the manifold along a serpentine path.

Various advantages of this invention will become apparent to those skilled in the art from the following detailed description of the invention, when read in light of the accompanying drawings.

### BRIEF DESCRIPTION OF THE DRAWINGS

FIG. 1 is a schematic view in elevation of a glass filament forming apparatus showing a cooling fin assembly in accordance with the invention.

FIG. 2 is an exploded perspective view of the cooling fin assembly of FIG. 1.

FIG. 3 is an assembled perspective view of the cooling fin assembly of FIG. 1.

FIG. 4 is a side view in elevation of a portion of the cooling fin assembly of FIG. 1, taken along the line 4-4 in FIG. 3.

FIG. 5 is a front cross-sectional view of the cooling fin assembly of FIG. 1 illustrating the serpentine flow of the cooling fluid.

FIG. 6 is a front view in elevation of a first embodiment of a baffle for use within the cooling fin assembly of FIG. 1.

FIG. 7 is a side view in elevation of the baffle of FIG. 6.

FIG. 8 is a front view in elevation of a second embodiment of a baffle for use within the cooling fin assembly of FIG. 1.

FIG. 9 is a front view in elevation of a third embodiment of a baffle for use within the cooling fin assembly of FIG. 1.

FIG. 10 is a front view in elevation of a fourth embodiment of a baffle for use within the cooling fin assembly of FIG. 1.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In accordance with embodiments of the present invention, improved methods and apparatus for cooling a filament forming area beneath a bushing are provided. The term “filament” as used herein, is defined to mean any fiber formed from a filament forming apparatus. The term “bushing”, as used herein, is defined to mean any structure, device or mechanism configured to supply molten glass to filament forming nozzles. The term “filament forming area”, as used herein, is defined to mean as area adjacent to filament forming nozzles. The term “manifold” as used herein, is defined to mean any structure, device or mechanism configured transfer heat away from the filament forming area. The term “blade” as used herein, is defined to mean any structure, device or mechanism configured transfer heat from the filament forming area to the manifold. The term “serpentine” as used herein, is defined to mean any non-linear path.

The description and figures disclose improved apparatus and methods configured for cooling a filament forming area beneath a bushing. Generally, the apparatus includes a fin assembly having a plurality of blades and a manifold. The manifold is configured to force a cooling fluid through a serpentine-shaped passage within the manifold.

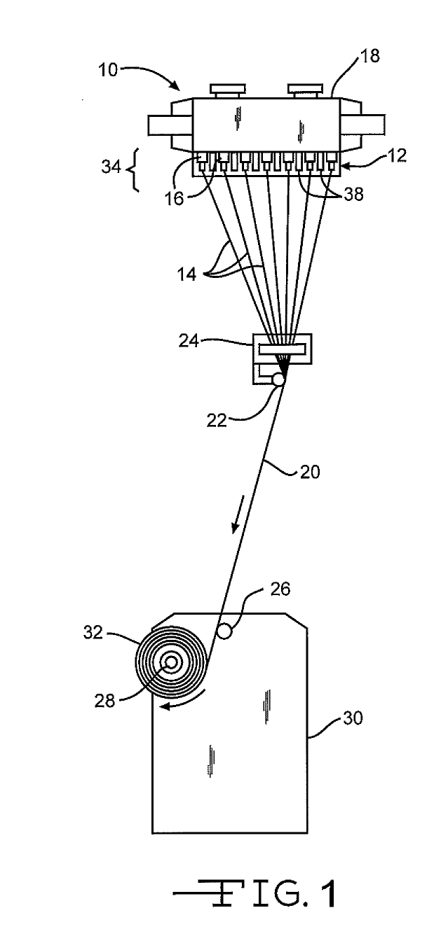

Referring now to the drawings, a glass filament forming apparatus is shown generally at 10 in FIG. 1. The glass filament forming apparatus 10 includes a cooling fin assembly 12. As shown in FIG. 1, filaments 14 are drawn from a plurality of nozzles 16 connected to a bushing 18. The filaments 14 can be gathered into a strand 20 by a gathering shoe 22. Optionally, size can be applied as a coating to the filaments 14 by a size applicator 24. A reciprocating device 26 is configured to guide the strand 20, which is wound around a rotating collet 28 in a winding apparatus 30 to build a cylindrical package 32.

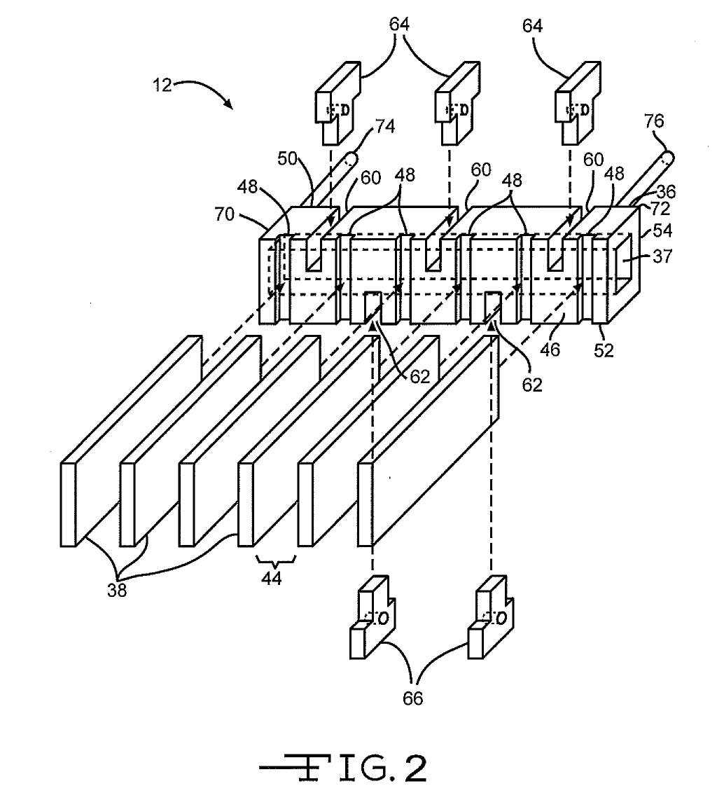

Referring again to FIG. 1, the cooling fin assembly 12 is located beneath the bushing 18 and is configured to cool or quench a filament forming area 34. As shown in FIGS. 2 and 3, the cooling apparatus 12 includes a manifold 36. The manifold 36 includes an internal fluid passage 37. The internal fluid passage 37 will be discussed in more detail below. The manifold 36 can have any desired length LM.

The cooling fin assembly 12 also includes a plurality of blades 38 coupled to the manifold 36. The blades 38 are spaced apart along the length LM of the manifold 36. The blades 38 are configured to absorb heat from the filament forming area 34 and conduct the absorbed heat to the manifold 36. In the illustrated embodiment, the blades 38 have a substantially rectangular cross-sectional shape. However, the blades 38 can have other desired cross-sectional shapes. While the illustrated embodiment shows a quantity of six blades 38, it should be appreciated that any desired number of blades 38 can be used.

Referring again to FIGS. 2 and 3, the blades 38 are spaced from adjacent blades 38, such that adjacent blades 38 define a space 44 therebetween. The spaces 44 allow the blades 38 to be mounted between individual rows, or groups of rows, of the nozzles 16 and permit the glass filaments 14 to pass on either side of the blades as shown in FIG. 1.

Referring again to FIGS. 2 and 3, the blades 38 are coupled to blade slots 48 formed in a front surface 46 of the manifold 36. The blades 38 can be coupled to the blade slots 48 in the front surface 46 of the manifold 36 in any desired manner, including the non-limiting example of brazing.

The blades 38 can be formed of any desired high temperature, corrosion resistant, heat transferring material. Non-limiting examples of blade material include copper, stainless steel, nickel, titanium, silver and alloys such as the non-limiting example of nickel-chromium-molybdenum-tungsten alloy. The blades 38 can have any desired dimensions and can have any desired surface, finish or coatings.

Referring again to FIGS. 2 and 3, the manifold 36 has a top surface 50, a bottom surface 52 and a back surface 54. The top surface 50 includes a plurality of top baffle slots 60 and the bottom surface 52 includes a plurality of bottom baffle slots 62. Generally, the top baffle slots 60 are configured to receive top baffles 64 and the bottom baffle slots 62 are configured to receive bottom baffles 66. The top baffles 64 and the bottom baffles 66 are inserted into the top and bottom baffle slots 60 and 62 such that a portion of the top and bottom baffles, 64 and 66, extend into the internal fluid passage 37. The extension of a portion of the top and bottom baffles, 64 and 66, into the internal fluid passage 37 provides for a serpentine flow of the internal cooling fluid.

The top and bottom baffles, 64 and 66, are connected to the manifold 36 in a manner such as to seal the top and bottom baffle slots, 60 and 62, thereby preventing leakage of the internal cooling fluid around the top and bottom baffles 64 and 66. Any desired method can be used to connect the baffles, 64 and 66, to the manifold 36 including the non-limiting example of silver brazing.

As shown in FIGS. 2 and 3, the manifold 36 has a first end 70 and a second end 72. The back surface 54 of the manifold 36 includes a first aperture (not shown) positioned substantially adjacent the first end 70. A first conduit 74 is connected to the first aperture. Similarly, the back surface 54 of the manifold 36 includes a second aperture (not shown) positioned substantially adjacent the second end 72. A second conduit 76 is connected to the second aperture. The first and second conduits, 74 and 76, are configured to supply cooling fluid to the manifold 36. The first and second conduits, 74 and 76, can have any desired size, shape and configuration.

The manifold 36 and the top and bottom baffles, 64 and 66, can be formed of any desired high temperature, corrosion resistant, heat transferring material. Non-limiting examples of manifold and baffle material include copper, stainless steel, nickel, titanium, silver and alloys such as the non-limiting example of nickel-chromium-molybdenum-tungsten alloy. The manifold 36 and the top and bottom baffles, 64 and 66, can have any desired surface, finish or coatings.

Referring now to FIG. 4, the manifold 36 has a width WM and a height HM. In the illustrated embodiment, the width WM and height HM of the manifold 36 are in a range of from about 0.75 inches to about 1.50 inches. Alternatively, the width WM and height HM of the manifold 36 can be less than about 0.75 inches or more than about 1.50 inches. In the illustrated embodiment, the resulting cross-sectional area of the manifold 36 is in a range of from about 0.56 sq. in. to about 2.25 sq. in. However, the cross-sectional area of the manifold can be less than about 0.56 sq. in. or more than about 2.25 sq. in.

While the manifold 36 illustrated in FIGS. 2-4 has a substantially rectangular cross-sectional shape, it should be appreciated that the manifold 36 can have other desired cross-sectional shapes.

Referring again to FIG. 2, the top surface 50, a bottom surface 52, front surface 46 and back surface 54 of the manifold 36 define the internal fluid passage 37. In the illustrated embodiment as shown in FIG. 4, the internal fluid passage 37 has the cross-sectional shape of a rounded rectangle. However, the internal fluid passage 37 can have other desired cross-sectional shapes.

The internal fluid passage 37 has a width WFP and a height HFP. In the illustrated embodiment, the width WFP and height HFP of the internal fluid passage 37 are in a range of from about 0.625 inches to about 1.50 inches. Alternatively, the width WFP and height HFP of the internal fluid passage 37 can be less than about 0.625 inches or more than about 1.50 inches.

The width WFP and height HFP of the internal fluid passage 37 result in a passage cross-sectional area. The size of the passage cross-sectional area can be a factor in the transfer of heat from the manifold 36 to the'cooling fluid passing through the manifold. In the illustrated embodiment, the ratio of the passage cross-sectional area to a manifold cross-sectional area is in a range of from about 40% to about 70%. In other embodiments, the ratio of the passage cross-sectional area to the manifold cross-sectional area can be less than about 40% or more than about 70%.

FIG. 4 illustrates a bottom baffle 66 positioned within the manifold 36. A portion of the bottom baffle 66 extends into the internal fluid passage 37. In the illustrated embodiment, the bottom baffle 66 extends into the internal fluid passage 37 such that the bottom baffle obstructs approximately 70% of the area of the internal fluid passage 37. In other embodiments, the bottom baffle 66 can extend into the internal fluid passage 37 such that the bottom baffle can obstruct an area of the internal fluid passage 37 that is more or less than approximately 70%. While the embodiment shown in FIGS. 2-4 illustrates the top and bottom baffles, 64 and 66, extending the same distance into the internal fluid passage 37, it is within the contemplation of this invention that various top and bottom baffles, 64 and 66, can extend different distances into the internal fluid passage 37.

Referring again to FIG. 4, the bottom baffle 66 includes an optional baffle aperture 78. Generally, the baffle aperture 78 is configured to allow a small portion of the flowing cooling fluid to pass through the bottom baffle 66 thereby substantially preventing an eddy from forming behind the bottom baffle 66. While the embodiment shown in FIG. 4 includes a baffle aperture 78, it should be understood that the cooling fin assembly 12 can be practiced without the baffle aperture 78. The baffle aperture 78 will be discussed in more detail below.

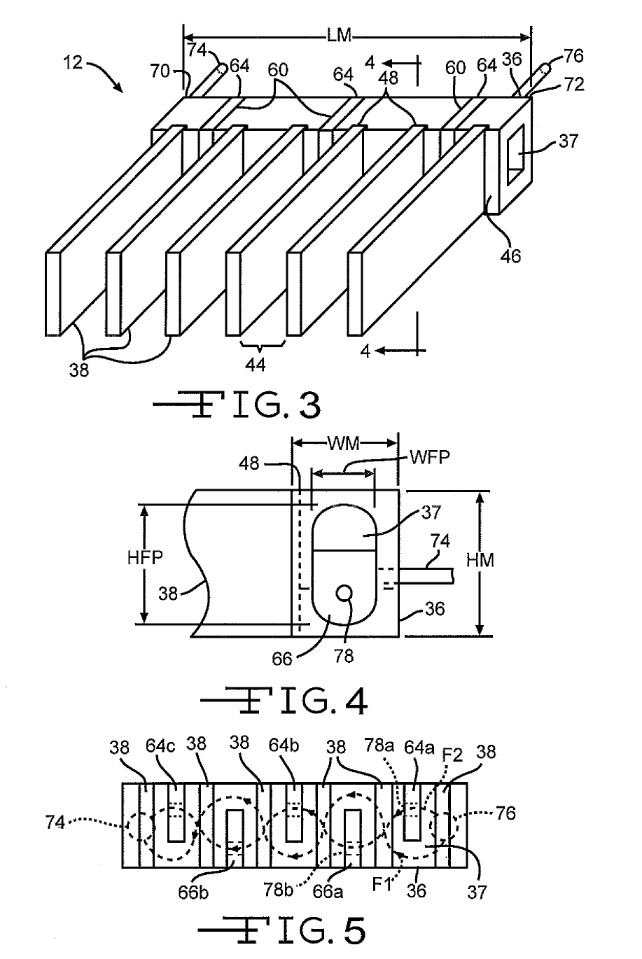

Referring now to FIG. 5, the manifold 36 includes the inserted top and bottom baffles 64a-64e and 66a-66b, and first and second conduits 74 and 76. As shown in FIG. 5, the top and bottom baffles 64a-64e and 66a-66b alternate within the manifold 36 thereby forming a serpentine path within the internal fluid passage 37. Various flows of the cooling fluid within the manifold 36 are illustrated. A first serpentine flow is illustrated by the path F1. A second flow, through the top and bottom baffles, 64a-64c and 66a-66b, is illustrated by the path F2. In operation, the cooling fluid enters the manifold 36 from the second conduit 76. A portion of the cooling fluid travels under the top baffle 64a along path F1 and a portion of the cooling fluid passes through the baffle aperture 78a along path F2. The cooling fluid passing through the baffle aperture 78a is configured to substantially prevent an eddy from forming along the path F1 and behind the top baffle 64a. Once past the top baffle 64a, the cooling fluids along paths F1 and F2 join together. Next, a portion of the cooling fluid travels over the bottom baffle 66a along path F1 and a portion of the cooling fluid passes through the baffle aperture 78b along path F2. The cooling fluid passing through the baffle aperture 78b is configured to substantially prevent an eddy from forming along the path F1 and behind the bottom baffle 66a. Once past the bottom baffle 66a, the cooling fluids along paths F1 and F2 join together. The process of alternating flows under the top baffles and over the bottom baffles, while a portion passes through the top and bottom baffles, is repeated until the cooling fluid exits the manifold 36 through the first conduit 74. As can be seen in FIG. 5, the serpentine flow of the cooling fluid, caused by the alternating pattern of top and bottom baffles, effectively increases the surface area of the manifold 36 exposed to the cooling fluid.

Referring again to FIG. 5, the cooling fluid flowing within the manifold 36 has a pressure and a flow rate. In the illustrated embodiment, the pressure of the cooling fluid is in a range of from about 20 psi to about 60 psi and the flow rate is in a range of from about 1.5 gpm to about 4.0 gpm. However, it should be appreciated that in other embodiments, the pressure of the cooling fluid can be less than about 20 psi or more than about 60 psi. It should further be appreciated that in other embodiments, the flow rate can be less than about 1.5 gpm or more than about 4.0 gpm.

As discussed above, the cooling fluid enters the manifold 36 from the second conduit 76, travels a serpentine path through the manifold 36 and finally exits the manifold 36 through the first conduit 74. As the cooling fluid travels through the manifold 36, the cooling fluid absorbs heat from the blades 38. The serpentine path of the cooling fluid provides for substantially uniform temperature of the cooling fluid as the cooling fluid flows through the manifold. In the illustrated embodiment, the difference in the temperature of the cooling fluid entering the manifold 36 and exiting the manifold 36 is in a range of from about 3° F. to about 15° F. In other embodiments, the difference in the temperature of the cooling fluid entering the manifold 36 and exiting the manifold 36 can be less than about 3° F. or more than about 15° F.

In the embodiment illustrated in FIG. 5, the top and bottom baffles, 64a-64c and 66a-66b, are positioned such that the baffles alternate on either side of the blades 38. The alternating pattern of the top and bottom baffles results in a single blade 38 having coolant flow both under the top baffle and over a bottom baffle. Accordingly, the coolant flow is maximized for each blade 38. However, it should be appreciated that other desired quantities and patterns of baffles can be used.

The manifold 36 having a serpentine flow of the cooling fluid advantageously provides a number of benefits. First, the serpentine flow produces consistent turbulence levels of the cooling fluid throughout the length of the manifold 36. The consistent turbulence level of the cooling fluid provides a higher overall rate of heat extraction from the filament forming area. A higher overall rate of heat extraction allows the glass filament forming apparatus 10 to be operated at higher throughput levels.

Second, a consistent turbulence level of the cooling fluid results in more uniformity of temperature along the length of the manifold 36. Uniformity of temperature along the length of the manifold 36 results in a decrease of mineral scale formation within the manifold 36 and a decrease of localized boiling of cooling fluid.

Third, the uniformity of temperature along the length of the manifold 36 also allows the use of less costly treatment of cooling fluid.

Fourth, the uniformity of temperature along the length of the manifold 36 results in a decrease of low cooling fluid flow areas or recirculation zones.

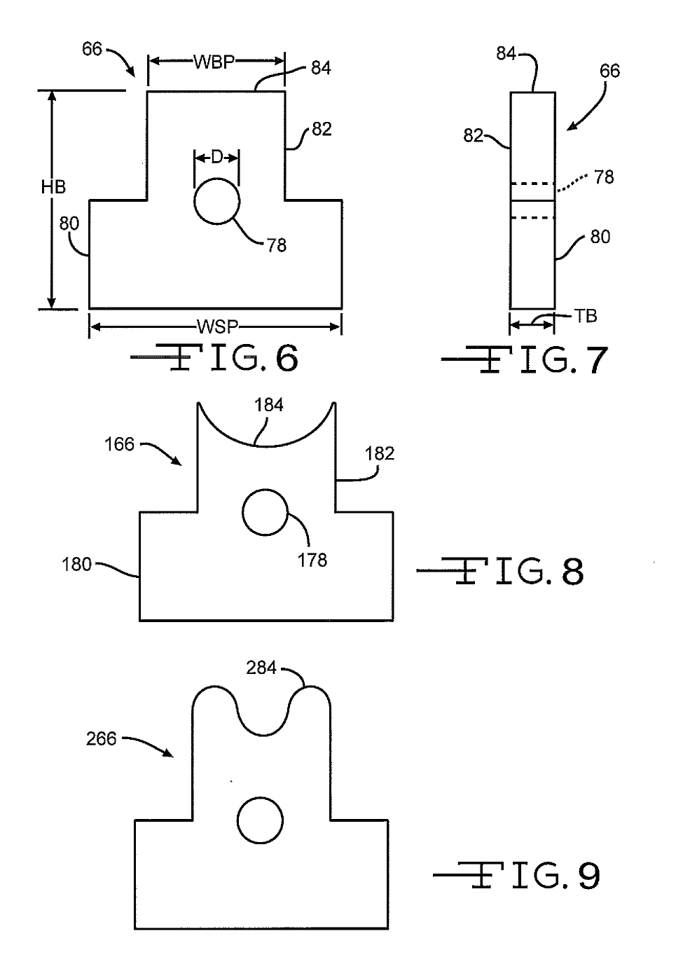

Referring now to FIGS. 6 and 7, a bottom baffle 66 is illustrated. The bottom baffle 66 is substantially the same as or similar to the top baffle 64, although it could be different. For purposes of brevity, only the bottom baffle 66 will be described. The bottom baffle 66 includes a seating portion 80, a blocking portion 82, a blocking edge 84 and the baffle aperture 78. The seating portion 80 is configured for positioning within the bottom baffle slot 62 as shown in FIG. 2. The blocking portion 82 is configured for extension into the passage 37 as discussed above.

The bottom baffle 66 has a height HB and a thickness TB. The height HB of the bottom baffle 66 is configured to extend the bottom baffles 66 a desired distance into the passage 37 as discussed above. In the illustrated embodiment, the height HB of the bottom baffle 66 is approximately 0.75 inches. However, the height HB of the bottom baffle 66 can be more or less than approximately 0.75 inches. The thickness TB of the bottom baffle is configured to correspond to the width of the bottom baffle slot 62. In the illustrated embodiment, the thickness TB of the bottom baffle 66 is approximately 0.125 inches. However, the thickness TB of the bottom baffle 66 can be more or less than approximately 0.125 inches.

Referring now to FIG. 6, the seating portion 80 has a width WSP and the blocking portion 82 has a width WBP. The width WSP of the seating portion 80 is configured to be substantially the same as the width WM of the manifold 36. In the illustrated embodiment, the width WSP is in a range of from about 0.75 inches to about 1.50 inches. Alternatively, the width WSP can be less than about 0.75 inches or more than about 1.50 inches.

Similarly, the width WBP of the blocking portion 82 is configured to be substantially the same as the width WFP of the internal fluid passage 37. In the illustrated embodiment, the width WSP is in a range of from about 0.625 inches to about 1.50 inches. Alternatively, the width WBP can be less than about 0.625 inches or more than about 1.50 inches.

As discussed above, the baffle aperture 78 is configured to allow a flow of cooling fluid to pass through the bottom baffle 66. In the illustrated embodiment, the baffle aperture 78 has a circular cross-sectional shape and a diameter D of approximately 0.19 inches. However, the baffle aperture 78 can have other desired cross-sectional shapes, such as for example a rectangular cross-sectional shape and a diameter D or major dimension of more or less than approximately 0.19 inches.

Without being bound by the theory, it is believed the shape of the blocking edge 84 contributes to the level of turbulence imparted by the baffles to the flow of the cooling fluid. In the embodiment shown in FIG. 6, the baffle edge 84 has a linear shape. However, the baffle edge can have other desired shapes intended to produce variations in the level of turbulence imparted by the baffles to the cooling fluid.

Referring now to FIG. 8, another embodiment of a bottom baffle 166 is illustrated. The bottom baffle 166 includes a seating portion 180, a blocking portion 182, a blocking edge 184 and the baffle aperture 178. The seating portion 180, blocking portion 182 and baffle aperture 178 are the same as or substantially similar to the seating portion 80, blocking portion 82 and baffle aperture 78 illustrated in FIG. 6 and discussed above. The blocking edge 184 has an inwardly arcuate shape.

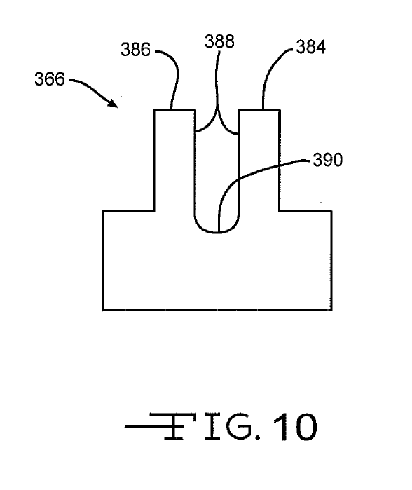

Referring now to FIG. 9, another embodiment of a bottom baffle 266 is illustrated. In this embodiment, the blocking edge 284 has a curvilinear shape.

It is further within the contemplation of the invention that the blocking portion of the baffles can have apertures configured for further turbulence inducing action. The apertures can have any desired cross-sectional shape or form including circles or slots.

Referring now to FIG. 10, another embodiment of a bottom baffle 366 is illustrated. In this embodiment, the blocking edge 384 includes both substantially horizontal portions 386 and substantially vertical portions 388. The substantially vertical portions 388 extend in a downward direction and join to form an arcuate portion 390. The arcuate portion 390 is configured to allow a portion of the flowing cooling fluid to pass through the bottom baffle 366 thereby substantially preventing an eddy from forming behind the bottom baffle 366, as described above for the baffle aperture 78. While in the embodiment illustrated in FIG. 10, the vertical portions 388 extend in a downward direction and join to form an arcuate portion 390, it should be appreciated that in other embodiments the vertical portions 388 can join to form any desired shape sufficient to allow a portion of the flowing cooling fluid to pass through the bottom baffle 366 thereby substantially preventing an eddy from forming behind the bottom baffle 366.

It is further within the contemplation of the invention that the blocking portion of the baffles can have apertures configured for further turbulence inducing action. The apertures can have any desired cross-sectional shape or form including circles or slots.

The principle and mode of operation of this invention have been described in certain embodiments. However, it should be noted that this invention may be practiced otherwise than as specifically illustrated and described without departing from its scope.

What is claimed is:

1. A cooling fin assembly constructed of materials suitable for use in the manufacture of glass filaments, the cooling fin assembly comprising:
a manifold having a first end, a second end and an internal passage therebetween, the internal passage being configured for a flow of cooling fluid;
a plurality of baffles positioned within the internal passage; and
a plurality of blades connected to the manifold, the blades being configured to conduct heat to the manifold;
wherein the baffles are configured to create a serpentine flow path for the cooling fluid within the manifold.

2. The cooling fin assembly of claim 1 wherein the manifold has a top surface and a bottom surface, wherein the baffles extend into the internal passage from the top surface and bottom surface.

3. The cooling fin assembly of claim 2 wherein the plurality of baffles are positioned in baffle slots located in the top surface and bottom surface.

4. The cooling fin assembly of claim 1 wherein the plurality of baffles have seating portions and blocking portions.

5. The cooling fin assembly of claim 4 wherein the blocking portions of the plurality of baffles extend into the internal passage.

6. The cooling fin assembly of claim 5 wherein the blocking portions of the plurality of baffles obstruct approximately 70% of the internal passage.

7. The cooling fin assembly of claim 6 wherein the blocking portions of the plurality of baffles extend into the internal passage different distances.

8. The cooling fin assembly of claim 1 wherein the plurality of baffles include baffle apertures configured to allow cooling fluid to pass through the plurality of baffles.

9. The cooling fin assembly of claim 8 wherein baffles are configured to separate the flow of the cooling fluid in the manifold into two flows, wherein the first flow follows a serpentine path within the manifold and around the baffles, and the second flow passes within the manifold and through the baffle apertures.

10. The cooling fin assembly of claim 2 wherein the manifold has a length, the baffles alternate extending from the top and bottom surfaces along the length of the manifold, and wherein blades are positioned between the alternating baffles along the length of the manifold.

11. The cooling fin assembly of claim 1 wherein the blades have a blocking edge, and wherein the blocking edge has an arcuate shape.

12. An apparatus configured for the manufacture of glass filaments, the apparatus comprising:
a bushing having a plurality of nozzles, the bushing being configured to provide a supply of molten glass to the plurality of nozzles, the plurality of nozzles being configured for the production of glass filaments, wherein the nozzles form a filament forming area;
a cooling fin assembly positioned in the filament forming area, the cooling fin assembly including a plurality of blades connected to a manifold, the manifold having a first end, a second end and an internal passage therebetween, the internal passage being configured for a flow of cooling fluid, a plurality of baffles being positioned within the internal passage, the plurality of blades being configured to conduct heat to the manifold, wherein the baffles are configured to create a serpentine flow path for the cooling fluid within the manifold; and
a mechanism configured to collect the formed filaments.

13. The apparatus of claim 12 wherein the manifold has a top surface and a bottom surface, wherein the baffles extend into the internal passage from the top surface and bottom surface.

14. The apparatus of claim 12 wherein the plurality of baffles include baffle apertures configured to allow cooling fluid to pass through the plurality of baffles.

15. The apparatus of claim 14 wherein the flow of the cooling fluid in the manifold separates into two flows, wherein a first flow follows a serpentine path through the manifold and a second flow passes through the baffle apertures.

16. The apparatus of claim 12 wherein the plurality of baffles obstruct approximately 70% of the internal passage.

18. The apparatus of claim 12 wherein the plurality of baffles extend into the internal passage different distances.

19. A method of manufacturing glass filaments including the steps of:
providing a bushing, the bushing configured to provide a supply of molten glass to the plurality of nozzles, the plurality of nozzles configured for the production of glass filaments, wherein the nozzles form a filament forming area;
positioning a cooling fin assembly in the filament forming area, the cooling fin assembly including a plurality of blades connected to a manifold, the manifold having a first end, a second end and an internal passage therebetween, the internal passage configured for a flow of cooling fluid, a plurality of baffles being positioned within the internal passage, the plurality of blades configured to conduct heat to the manifold, wherein the baffles are configured to create a serpentine flow path for the cooling fluid within the manifold;
providing a supply of molten glass to the bushing;
forming glass filaments through the nozzles;
providing a flow of cooling fluid through the manifold;
absorbing and conducting heat from the filament forming area to the manifold; and
transferring heat from the manifold to the cooling fluid as the cooling fluid flows through the manifold along a serpentine path.

20. The method of claim 19 wherein the flow of the cooling fluid in the manifold separates into two flows, wherein a first flow follows the serpentine path through the manifold and a second flow passes through baffle apertures.
